(19) United States
(12) Patent Application Publication
(10) Pub. No.: US 2013/0344223 A1
(43) Pub. Date: Dec. 26, 2013

(54) Alcoholic Flavored Mixed Drink

(71) Applicant: Joey Thomas, Richardson, TX (US)

(72) Inventor: Joey Thomas, Richardson, TX (US)

(21) Appl. No.: 13/528,656

(22) Filed: Jun. 20, 2012

(51) Int. Cl. C12G 3/06

(52) U.S. Cl. CPC C12G 3/06
USPC 426/592

(57) ABSTRACT

A method for producing an alcoholic drink mixture may include the steps of forming the alcoholic drink mixture by adding a flavored drink mix, further forming the alcoholic drink mixture by adding an alcoholic drink and further forming the alcoholic drink mixture by adding water.

### FIELD OF THE INVENTION

The present invention relates to a drink mixture and more particularly to an alcoholic drink.

### BACKGROUND

U.S. Pat. No. 7,001,638 discloses the isolation of at least one water soluble glycoside including an aromatic moiety group conjugated to mono-, di-, and trisaccharides from hop plant parts other than hop cones is disclosed. A glycoside preparation made by extraction of hop plant leaves with an aqueous alcohol was discovered to confer a pleasant grape flavor to the beer to which the glycoside preparation was added. The glycoside composition of the glycoside preparation made from aqueous alcohol-extracted hop plant leaves was found to differ from a similar preparation made from hop cones.

U.S. Pat. No. 6,723,304 relates to oral care compositions such as toothpaste, gels, tooth powders, mouthwashes, mouth rinses, gums, mouth sprays and lozenges comprising diglycerol. The diglycerol is used as a humectant in the compositions. The compositions may further comprise water, flavoring agents, active compounds, emulsifier, alcohol, sweeteners, thickening agents, surfactants, suspending agents, astringent and toning drug extracts, flavor correctants, abrasives or polishes, deodorizing agents, preservatives, flavoring buffers, whitening agents, wound-healing and inflammation inhibiting substances, colorants, dyes, pigments, abrasives, polishes, antimicrobial agents, pH buffers and other additives and fillers.

U.S. Pat. No. 5,591,474 discloses preparing a Chocolate crumb, to be used later in the manufacture of milk chocolate. One feature of milk chocolate, and the chocolate crumb which is a major constituent thereof, is that the sugar is at least partially caramelized, and the caramelization contributes to the flavor of the milk chocolate. The present invention provides a process whereby only a portion of the sugar constituent of the chocolate crumb is first caramelized by being hydrated with a portion of the milk which is to be utilized in the process. That hydrated sugar with the milk is heated so as to caramelize the sugar and so as to substantially drive off the water constituent of that first portion of the milk. The temperature and the length of time for which the heating continues will govern the degree of caramelization. The then caramelized slurry batch is added to the remainder of the milk to be used, and dried so as to drive off the remaining water carried into the mix by the additional milk. That dried mix is thereafter mixed with anhydrous cocoa butter and anhydrous cocoa liquor in the proper amounts so as to form the chocolate crumb; and if the fat constituency is too low, such as when skim milk has been used, an additional amount of anhydrous butter fat can be added to the final mix to bring the final analysis of the total amount of dried milk solids and anhydrous butter fat up to specified amounts for milk chocolate. This process provides a more economical way to produce chocolate crumb, since there is less requirement for large and expensive caramelization and heat exchange equipment, and the process is easier to control.

U.S. Pat. No. 4,978,547 discloses a process for producing low alcoholic wine including the steps: evaporating alcohol-containing wine in a vacuum evaporator so that a first mixture comprising water, alcohol and flavoring substance is separated from a second mixture having a low-alcoholic content, separating water from said first mixture in a multistage flavor substance apparatus and drawing off a third mixture comprising alcohol and flavoring substance, distilling alcohol from the third mixture, adding the water from the multistage flavor substance apparatus to a mixing vessel in an amount, which together with the low-alcohol second mixture and the flavoring substances produces a quantity of low-alcoholic wine having an alcoholic content below legally determined values for low-alcoholic wine, the process allowing only outputs of low-alcoholic wine, distilled alcohol and flavoring substances and inputs of essentially only the alcohol-containing wine.

U.S. Pat. No. 4,900,574 discloses a soluble or dissolved tea product which, when in water, provides a tea beverage with acceptable flavor quality. A tea liquor is prepared by extraction of leaf tea with hot water, a water-soluble caseinate (e.g. sodium caseinate) is added after tea cream formation upon cooling, or is added after tea cream formation to solubilize the latter. The liquor can be cold concentrated, and if necessary dried to form a solid product, e.g. by reverse osmosis followed by freeze drying.

U.S. Pat. No. 4,420,471 discloses a method for preparing visually clear, stable aqueous citrus flavored mouthwash compositions. The procedure reduces flammability hazards associated with mixing volatile alcohols and eliminates the necessity of certain production equipment. The method for formulating the liquid mouthwash comprises from about 0.01% to about 0.5% of citrus flavor oil, about 0.1% to about 2.0% emulsifier, about 1% to about 25% C.sub.2-3 alcohol and about 60% to about 95% water, wherein the steps include: (a) preparing a blend of the alcohol with the citrus flavor oil; (b) preparing a second blend of water and the emulsifier; (c) subsequently combining blends (a) and (b); and (d) intimately mixing the resultant combination.

U.S. Pat. No. 4,178,389 discloses an alcoholic beverage of good clarity and alcohol content in the 12-16% by volume range, namely wine or cider, is made in a space of about 28 days by mixing together water, sugar and a rapid ferment and flavor conferring composition, maintaining the mixture under fermentation conditions for about 28 days, and then removing the liquor from the solid sediment. The composition comprises a mixture of, firstly, the dried granulated product prepared by mixing the yeast nutrients ammonium phosphate, urea, monobasic potassium phosphate and tricalcium phosphate with water to form a paste, then drying and granulating the solid mixture from the paste; and, secondly, a combination of flavor conferring and fermentation ingredients including a wine yeast, food grade lecithin, calcium carbonate, sodium citrate and an organic acid such as malic acid. For a wine beverage, freeze-dried wine powder may be added. For a cider beverage, apple juice powder is added.

U.S. patent application 20080311275 provides an alcohol-containing wasabi, a wasabi extract solution and a wasabi extract capable of stably maintaining flavor and pungent taste of freshly harvested wasabi for a long period of time. The alcohol-containing wasabi is prepared by impregnating wasabi with alcohol. The method for obtaining the alcohol-containing wasabi comprises the steps of impregnating the mass of wasabi with alcohol by permitting wasabi to contact alcohol or an alcohol aqueous solution, and allowing wasabi to stand for 20 minutes or more at a temperature from 5 to 60.degree. C. The wasabi extract solution is obtained by distilling of the alcohol-containing wasabi. The wasabi extract is obtained by diluting the wasabi extract solution with water to an alcohol concentration of 30% by weight or less to form precipitates, and by filtering the precipitate.

These patents and patent applications are incorporated by reference in their entirety.

### SUMMARY

A method for producing an alcoholic drink mixture may include the steps of forming the alcoholic drink mixture by adding a flavored drink mix, further forming the alcoholic drink mixture by adding an alcoholic drink and further forming the alcoholic drink mixture by adding water.

The quantity of alcoholic drink may be substantially two ounces.

The quantity of water may be in the range of substantially 6 to 7 ounces.

The quantity flavored drink mix may be in the range of substantially 1.1 g to 2.2 g.

The flavored drink mix may be Crystal light.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the ingredients of the present invention;

FIG. 2 illustrates the method of the present invention.

### DETAILED DESCRIPTION

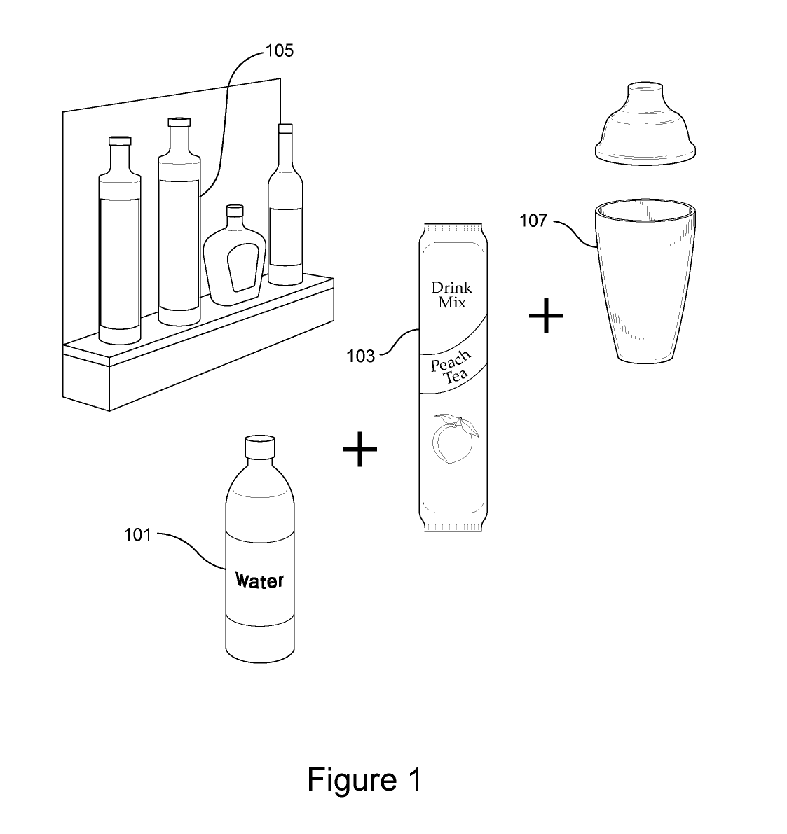

FIG. 1 illustrates the ingredients of the invention which may include water 101 which may be bottled water, tap water or other sources of water, a flavored drink mix 103 which may be artificially flavored, sugar-free, non-sugar-free and an alcoholic drink 105 which may be vodka, rum, tequila or other appropriate alcoholic drinks.

FIG. 1 additionally illustrates a mixing vessel 107 which may be used to mix the ingredients of the invention. The following steps may be performed in any order.

The flavored drink mix 103 may be added to the mixing vessel 107, and the range of the flavored drink mix 103 may be between substantially 2.2 g and be substantially 1.1 g.

The alcoholic drink 105 may be added to the mixing vessel 107 and the quantity of the alcoholic drink 105 may be substantially 2 ounces.

The resulting first composition of matter which may be an alcoholic mixture defined by the combining of the flavored drink mix 103 and the alcoholic drink 105 may be consumed by a user.

Alternatively in another embodiment, the water 101 may be added to the flavored mixed drink 103 and the alcoholic drink 105 in the mixing vessel 107 in the range of substantially 6 to 7 ounces of water 101. The resulting second composition of matter which may be an alcoholic mixture defined by combining the flavored drink mix 103, the alcoholic drink 105 and the water 101.

The flavored drink mix may be Crystal light or other appropriate flavored drink mix. Other quantities of the alcoholic mixture may be obtained by substantially maintaining the above ratio of flavored drink mix 103, the alcoholic drink 105 and the water 101.

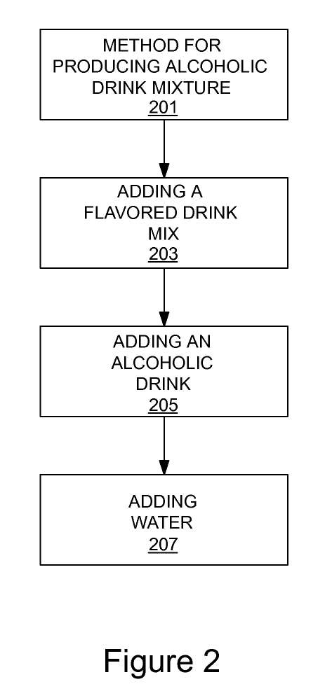

FIG. 2 illustrates the steps of the present invention and illustrates the beginning of the method in step 201. The flavored drink mix is added in step 203, and the alcoholic drink is added in step 205. In step 207, the water is added.

Crystal Light flavors include:
Refreshment series: Crystal Light classic flavors
   Lemonade
   Cranberry Apple
   Fruit Punch
   Pink Lemonade
   Raspberry Ice
   Raspberry Lemonade
   Strawberry Kiwi
   Strawberry Orange Banana
   White Grape
Sunrise series: Crystal Light with 100% Daily Value of vitamin C and 10% Daily Value of calcium per serving
   Classic Orange
   Ruby Red Grapefruit
   Tangerine Strawberry
Tea series: Crystal Light tea varieties
   Green Tea Honey Lemon
   Green Tea Raspberry
   Iced Tea
   Raspberry Tea
   Peach Iced Tea
   Decaffeinated Iced Tea
   Green Tea Peach Mango
Enhanced series: Crystal Light containing (or specially formulated with) select ingredients
   ENERGY Wild Strawberry
   ENERGY Grape
   ENERGY Peach Mango (available exclusively at Walmart)
   FOCUS Citrus Splash
   HUNGER SATISFACTION Strawberry Banana
   ANTIOXIDANT Cherry Pomegranate
   METABOLISM+ Green Tea Peach Mango
   FIBER Raspberry Peach
Skin Essentials series: Crystal Light with antioxidant vitamins and a plant extract to help nourish skin from within when two 16.9 fl. oz. servings per day are consumed
   White Peach Tea
   Pomegranate Lemonade
Mocktail series: Crystal Light's new non-alcoholic party drinks
   Margarita
   Mojito
   Appletini
   Pomtini
   Peach Bellini
      Crystal Light Pure flavors include:
Grape
Strawberry Kiwi
Tropical Blend
Mixed Berry
Lemonade

Crystal Light may include a powdered drink mix that may be available in many fruit and tea flavors. Crystal Light may be low-calorie and sugar-free. This makes Crystal light a popular drink for people who are trying to lose weight or ensure that they get enough water throughout the day. Some of the ingredients in Crystal Light follow.

### Sweeteners

Since Crystal Light is sugar free, another sweetener may be added. The main sweetener in Crystal Light may be aspartame. Aspartame was the subject of several studies to determine if its consumption could raise a person's risk of developing cancer. The United States National Cancer Institute reported that a 2006 study showed no increase in brain cancer, lymphoma, or leukemia among the study subjects who used aspartame.

Other sweeteners that may be present in Crystal Light include corn syrup solids, maltodextrin and acesulfame potassium. Corn syrup solids may be concentrated amounts of corn syrup that contain 10 percent or less water. Maltodextrin is a starch sweetener made from rice, corn or potato. Acesulfame potassium is an artificial sweetener that is much stronger than sugar and often paired with aspartame.

### Flavoring

Citric acid is an ingredient in many flavors of Crystal Light. This ingredient adds a tart flavor and also is a preservative to help Crystal Light have a longer shelf life.

Natural and artificial flavors give Crystal Light certain tastes. However, the amount of these ingredients is generally less than 2 percent of the total mixture. Some varieties of Crystal Light contain juice solids as well.

### Preservatives

To keep Crystal Light powder fresh, many flavors contain BHA (butylated hydroxyanisole). Sodium benzoate also helps maintain the product's freshness. Magnesium oxide is another common preservative in Crystal Light. This ingredient keeps the powder from caking.

### Health Formulas

Crystal Light varieties with antioxidant ingredients include vitamins C and E. Beta carotene and various forms of potassium are also ingredients in Crystal Light Antioxidant drinks.

Crystal Light Skin Essentials contain ingredients to keep your skin healthy. These flavors include some of the same ingredients that you will find in the Antioxidant formulas as well as marigold flower extract.

Crystal Light Calcium may include enough calcium to equal 10 percent of your daily recommended value. This percentage assumes a 2,000-calorie daily diet.

Crystal Light LiveActive may include inulin, a fiber for digestive health. Assuming a 2,000-calorie daily diet, the LiveActive formula will give you 12 percent of your daily fiber.

### Other Ingredients

Crystal Light tea varieties contain instant tea. Depending on the variety, the tea may or may not contain caffeine. Some varieties of Crystal Light may include artificial coloring. These may include red 40, yellow 5 and blue 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method for producing an alcoholic drink mixture, comprising the steps of:
forming the alcoholic drink mixture by adding a flavored drink mix;
further forming the alcoholic drink mixture by adding an alcoholic drink;
further forming the alcoholic drink mixture by adding water.

2. A method for producing an alcoholic drink mixture as in claim 1, wherein the quantity of alcoholic drink is substantially two ounces.

3. A method for producing an alcoholic drink mixture as in claim 1, wherein the quantity of water is in the range of substantially 6 to 7 ounces.

4. A method for producing an alcoholic drink mixture as in claim 1, wherein the quantity flavored drink mix is in the range of substantially 1.1 g to 2.2 g.

5. A method for producing an alcoholic drink mixture as in claim 1, wherein the flavored drink mix is Crystal light.
